(19) United States
(12) Patent Application Publication
(10) Pub. No.: US 2008/0074274 A1
(43) Pub. Date: Mar. 27, 2008

(54) Diaper

(75) Inventors: Ying-Chiang Hu, Hsinchu (TW); Hung-Hsin Tsai, Hsinchu (TW); Chun-Hsun Chu, Hsinchu (TW); Tzong-Che Ho, Hsinchu (TW)

Correspondence Address: BIRCH STEWART KOLASCH & BIRCH, PO BOX 747, FALLS CHURCH, VA, 22040-0747, US

(73) Assignee: Industrial Technology Research Institute, Hsinchu (TW)

(21) Appl. No.: 11/654,559

(22) Filed: Jan. 18, 2007

(30) Foreign Application Priority Data
Sep. 26, 2006 (TW) 095135545

(51) Int. Cl. G08B 23/00

(52) U.S. Cl. 340/573.5

(57) ABSTRACT

The present invention provides a diaper including a body, a sensing module disposed on the body for detecting humidity of the body and wirelessly transmitting an electrical signal converted from the humidity and a receiving module for receiving the electrical signal transmitted by the sensing module and generating an alarm signal.

### BACKGROUND OF THE INVENTION

1. Field of the Invention

The present invention relates to an intelligent diaper capable of transmitting wireless signals, and more particularly to an intelligent diaper capable of detecting relative humidity inside the intelligent diaper by a micro humidity sensing module and transmitting a corresponding signal to an external receiving module by wireless transmission mechanism for automatically detecting the variance of the humidity inside the diaper.

2. Description of the Related Art

An appropriate time to replace a wearer's diaper is usually based on whether the humidity inside the diaper rises significantly due to the wearer urinating. Traditionally there are two methods for determining the appropriate time for replacing the diaper, one is to touch the diaper through hands by mother or nurses to gauge whether the humidity inside the diaper is too high, while the other is to wait for the wearer crying or expressing unpleasant emotion due to over-wetness of the diaper. Beyond the above two methods, a third diaper-humidity monitoring method is developed to overcome the inconveniences of the above two methods. According to the third method, a wetness-sensing diaper comprises a humidity sensor, and a display is attached to the exterior surface of the diaper to bring a color change when the humidity sensor detects the humidity is too high. So that, the wearer's mother or nurses know the diaper is too wet and needed to be replaced from seeing the color change of the display attached on the exterior surface of the diaper.

U.S. Pat. Nos. 5,291,181, 5,903,222, 6,433,695, 6,580,013, 6,870,479, 6,677,859 and 6,583,722 have disclosed various kinds of diaper-humidity sensing and warning devices. It is known that ordinary sensing devices utilize two non-touched conductive materials with a water-absorbing material contacting therebetween. The water-absorbing material is used to absorb urine so as to turn on the loop, and thus the resistance is reduced, by which to determine whether the humidity inside the diaper is at the highest level. The above sensing method only sends two signals respectively in response to turn on or turn off of the loop, which can not respond how much the humidity inside the diaper is.

Accordingly, how to know the humidity inside the diaper and avoiding the skin covered inside the diaper from being in a high-humidity and high-risk environment, and thus reducing the risk of getting diaper rash are urgent to be overcome.

### SUMMARY OF THE INVENTION

The present invention provides a diaper with a humidity sensing and alarm device for monitoring the humidity inside the diaper, transmitting a warning signal to a receiving device through a wireless transmission module inside the diaper, and transmitting the warning signal through the receiving device to inform a nursing people to change or deal with the diaper to avoid the skin of the diaper's wearer covered inside the diaper staying in a high-humidity and high-risk environment so as to reduce the risk of getting diaper rash.

A diaper of the present invention comprises a body, a sensing module disposed on the body for detecting the humidity of the body and wirelessly transmitting an electrical signal converted from the humidity and a receiving module for receiving the electrical signal transmitted through the sensing module and generating an alarm.

The sensing module includes a humidity sensing element, a signal processor, a micro power supply and a signal transmitter.

The sensing module is disposed on a flexible circuit board, and the flexible circuit board can be a polyimide film (PI).

The sensing module is disposed on a flexible circuit board, and the flexible circuit board can be a polyester film (PET).

The sensing module can be a disposable sensing module.

The sensing module can be a reusable sensing module.

The material of the humidity sensing element is polymer material.

The micro power supply is a micro battery cell.

The micro power supply is a flexible battery cell.

The signal transmitter is a micro antenna for transmitting wireless signal.

The signal frequency of the micro antenna can be 125-34 kHz or 13.56 MHz.

The signal frequency of the micro antenna can be 400-900 MHz, 2.45 GHz or 5.8 GHz.

The signal transmitter is a micro speaker.

The receiving module includes an alarm for generating a warning by whistling, lighting or glittering to notify exchanging the diaper.

The receiving module is a mobile device.

According to the above-mentioned, the present invention provides an intelligent diaper having a humidity sensing module embedded therein for transmitting wireless signals. The diaper is also capable of detecting the humidity inside the diaper by a wetness sensor disposed therein and accordingly informing a receiving device. When the humidity inside the diaper rises up, the resistance of the humidity sensing module is reduced due to an increase of ambient gasified water. The reduced resistance value is transmitted from the humidity sensing module to a signal processor to be processed as a signal and passed to the micro antenna, and then the signal is transmitted from the micro antenna to the receiving module. After receiving the signal, the receiving module converts the reduced value of the resistance to a rising level of the humidity inside the diaper, and the humidity inside the diaper is displayed on the receiving module. When the rising humidity inside the diaper is determined to exceed a critical value, the receiving module generates an alarm signal to inform the extraordinary humidity inside the diaper.

### BRIEF DESCRIPTION OF THE DRAWINGS

FIG. 1 shows a diagram of a diaper according to an embodiment of the present invention.

FIG. 2 shows a block diagram of a sensing module and a receiving module of the diaper according to the embodiment of FIG. 1.

FIG. 3 shows a diagram of a diaper according to another embodiment of the present invention.

FIG. 4 shows a block diagram of a sensing module and a receiving module of the diaper according to the embodiment of FIG. 3.

### DETAILED DESCRIPTION OF THE PREFERRED EMBODIMENTS

While the invention has been described by way of examples and in terms of preferred embodiments, it is to be understood that those who are familiar with the subject art can carry out various modifications and similar arrangements and procedures described in the present invention and also achieve the effectiveness of the present invention. Hence, it is to be understood that the description of the present invention should be accorded with the broadest interpretation to those who are familiar with the subject art, and the invention is not limited thereto.

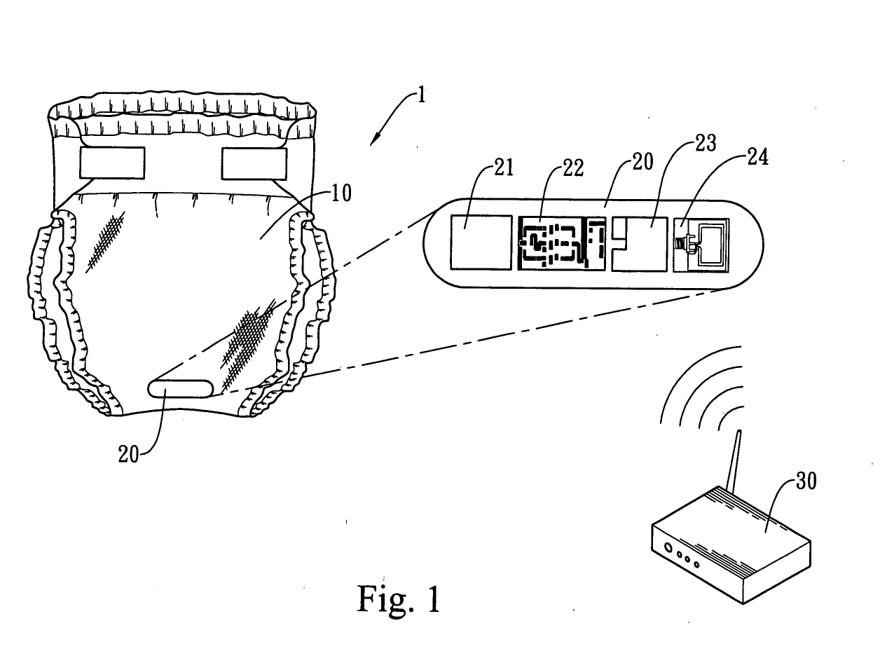

FIG. 1 shows a diagram of a diaper according to an embodiment of the present invention. The diaper 1 of the present invention comprises a body 10, a sensing module 20 disposed on the body 10 for detecting humidity of the body and wirelessly transmitting an electrical signal converted from the humidity, and a receiving module 30 for receiving the electrical signal transmitted from the sensing module 20 and generating an alarm signal.

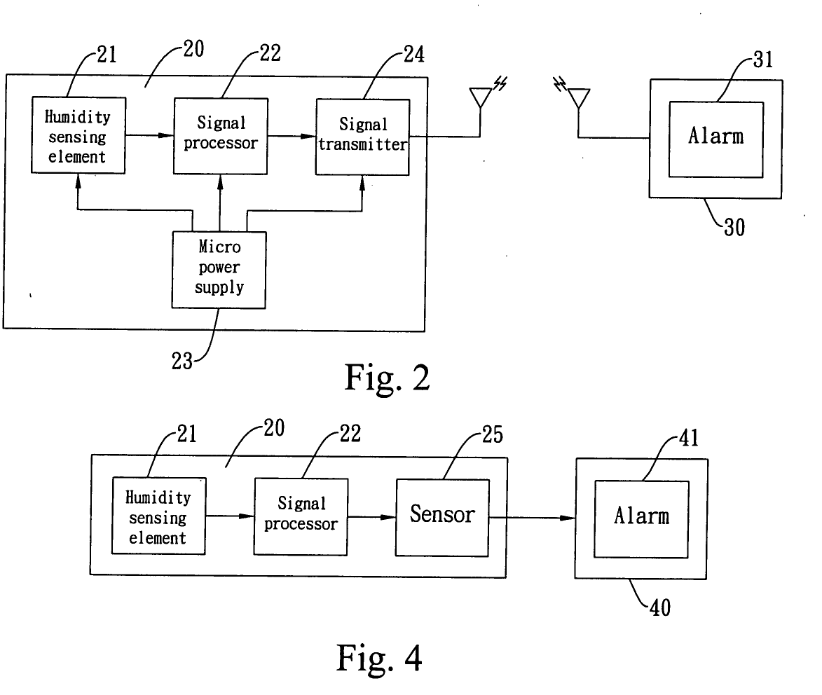

Further referring to FIG. 2, it shows a block diagram of a sensing module and a receiving module of the diaper according to the embodiment of the present invention. The diaper 1 of the present invention comprises a sensing module 20 having a humidity sensing element 21 for detecting the humidity of the body 10, a signal processor 22 for converting the humidity detected by the humidity sensing module 21 to an electrical signal, a micro power supply 23 for providing power to the sensing module 20 for activating the sensing module 20, and a signal transmitter 24 for receiving the electrical signal from the signal processor 22 and transmitting a wireless signal converted from the electrical signal to the receiving module 30.

According to the above embodiment, the sensing module 20 is disposed on a flexible circuit board such that the sensing module 20 can be attached onto the body 10, and therefore the sensing module 20 can be a disposable sensing module or a reusable sensing module. Furthermore, the material of the flexible circuit board can be a polyimide film (PI) or a polyester film (PET).

Besides, the signal processor 22 is used to amplify the converted electrical signal to improve signal quality, and transmit the amplified signal to the signal transmitter 24.

The material of the humidity sensing element 21 is a polymer material. The micro power supply 23 is a micro battery cell or a flexible battery cell. The signal transmitter 24 is a micro antenna for transmitting wireless signal or a micro speaker. According to the embodiment, the signal frequency of the micro antenna can be 125-134 kHz, 13.56 MHz, 400-900 MHz, 2.45 GHz or 5.8 GHz.

The receiving module 30 has an alarm 31 for informing the diaper's wearer's parents, families, babysitter or nurses to change the diaper by whistling, lighting or glittering after receiving the electrical signal from the sensing module 20. And the receiving module 30 can be carried by the diaper's wearer's parents, families, babysitter or nurse as a mobile device.

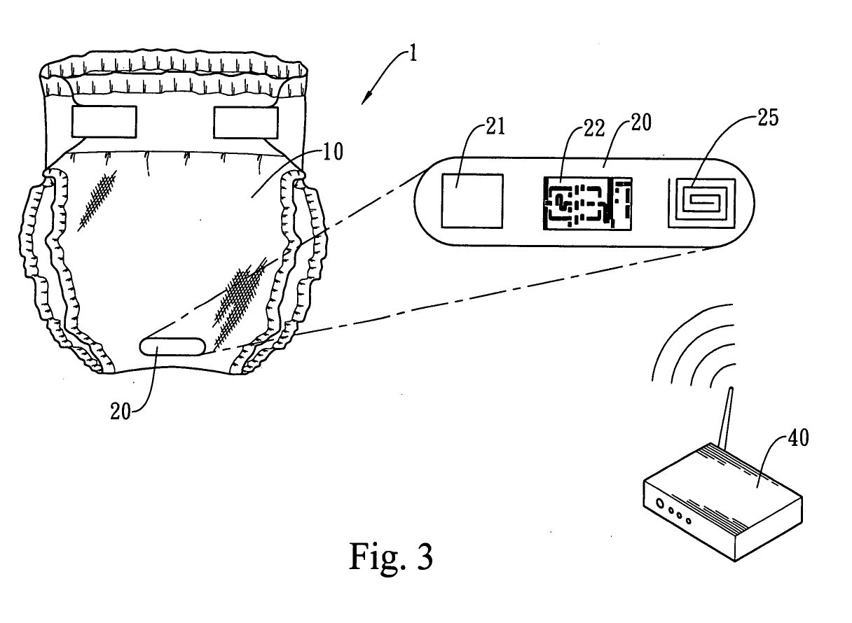

FIG. 3 shows a diagram of the diaper according to another embodiment of the present invention. The diaper 1 of the present invention comprises a body 10, a sensing module 20 disposed on the body 10 for detecting humidity of the body 10 and wirelessly transmitting an electrical signal converted from the humidity, and a transmitting/receiving module 40 for providing power to the sensing module 20 coupled with said transmitting/receiving module to generate a induction current and receiving the electrical signal from the sensing module 20 to send out an alarm signal accordingly.

FIG. 4 shows a block diagram of a sensing module and a receiving module of the diaper according to the above embodiment of the present invention. The sensing module 20 of the present invention comprises a humidity sensing element 21 for detecting humidity of the body 10, a signal processor 22 for converting humidity detected by the humidity sensing element 21 to an electrical signal, and an inductance 25 for inducting an induction current from the power of the transmitting/receiving module 40. So that the sensing module 20 can be used to detect the humidity of the body 10 of the diaper, and then the transmitting/receiving module 40 is used to readout a signal from the inductance 25.

According to the above embodiment of the present invention, the sensing module 20 is disposed on a flexible circuit board such that the sensing module 20 can be attached onto the body 10, and therefore the sensing module 20 can be a disposable sensing module or a reusable sensing module. Furthermore, the material of the flexible circuit board can be a polyimide film (PI) or a polyester film (PET).

Besides, the signal processor 22 is used to amplify the converted electrical signal to improve signal quality, and transmit the amplified signal to the signal transmitter 24.

The material of the humidity sensing element 21 is a polymer material. The transmitting/receiving module 40 has an alarm 41 for informing the diaper's wearer's parents, families, babysitter or nurse by whistling, lighting or glittering to change the diaper after receiving the electrical signal from the sensing module 20. And the receiving module 30 can be set on a baby cot, a sickbed or a room bed as a fixed device.

As such, the diaper 1 of the present invention primarily comprises a body 10 and a sensing module 20. The sensing module 20 can be classified into two types of active transmission and passive induction. According to FIG. 1 and FIG. 2, an active transmission sensing module 20 comprises a humidity sensing element 21, a signal processor 22, a micro power supply 23 and a signal transmitter 24. Extraordinary humidity raised inside the diaper makes the electrical characteristic of the humidity sensing element 21 change, and then making the electrical characteristic of the humidity sensing element 21 differ from the ordinary electrical characteristic. As such, the active sensing module 20 monitors wetness based on the difference of the electrical characteristic. The difference of the electrical characteristic will be transmitted to the signal processor 22 for signal processing and amplification, and then transmitted to the receiving module 30 by the micro antenna of the signal processor 24. And, the power source of the active sensing module 20 is supplied from the micro power supply 23.

According to FIG. 3 and FIG. 4, the passive induction sensing module 20 does not require an external power but requires a sensor 25. When the sensor 25 is closed to the transmitting/receiving module 40, the sensor 25 inducts an induction current from the power of the transmitting/receiving module 40. The induction current successively passed through the humidity sensing element 21 and the signal processor 25 of the sensing module 20. After passing the humidity sensing element 21, the current memorizes the electrical characteristic affected from humidity variation of the humidity sensing element 21, and transmits the variation of the electrical characteristic to the signal processor 22 for processing and amplification. Then, the signal is transmitted back to the sensor 25, and the transmitting/receiving module 40 reads out the signal of the sensor 25. When the transmitting/receiving module 40 reads information that the humidity sensing module 20 inside the diaper detects extraordinary humidity, the transmitting/receiving module generates a high-decibel alarm signal to cause attention of a nurse staying nearby so that the nurse can replace a fresh and dry diaper immediately.

As such, the diaper of the present invention has features such as easily use, simple manufacturing process, and intelligent wetness monitoring and wirelessly alarm signal transmission by associating with wireless technology. It satisfies the user demands and also improves the market potential and competitiveness in this industry.

While the invention has been described by way of examples and in terms of preferred embodiments, it is to be understood that the invention is not limited thereto. To the contrary, those who are familiar with the subject art can carry out various modifications and similar arrangements and procedures, under the scope of appended claims and broadest interpretation.

What is claimed is:

1. A diaper, comprising:
a body;
a sensing module disposed on said body for detecting humidity of said body and wirelessly transmitting an electrical signal converted from the humidity; and
a receiving module for receiving said electrical signal transmitted by said sensing module and accordingly generating a warning signal.

2. The diaper as claimed in claim 1, wherein said sensing module comprises a humidity sensing element, a signal processor, a micro power supply and a signal transmitter.

3. The diaper as claimed in claim 1, wherein said sensing module is disposed on a flexible circuit board comprising a polyimide film (PI).

4. The diaper as claimed in claim 1, wherein said sensing module is disposed on a flexible circuit board, and said flexible circuit board comprising a polyester film (PET).

5. The diaper as claimed in claim 1, wherein said sensing module is a disposable sensing module.

6. The diaper as claimed in claim 1, wherein said sensing module is a reusable sensing module.

7. The diaper as claimed in claim 2, wherein the material of said humidity sensing element is polymer material.

8. The diaper as claimed in claim 2, wherein said micro power supply is a micro battery cell.

9. The diaper as claimed in claim 2, wherein said micro power supply is a flexible battery cell.

10. The diaper as claimed in claim 2, wherein said signal transmitter is a micro antenna for transmitting wireless signal.

11. The diaper as claimed in claim 10, wherein the signal frequency of said micro antenna is 125-134 kHz.

12. The diaper as claimed in claim 10, wherein the signal frequency of said micro antenna is 13.56 MHz.

13. The diaper as claimed in claim 10, wherein the signal frequency of said micro antenna is 400-900 MHz.

14. The diaper as claimed in claim 10, wherein the signal frequency of said micro antenna is 2.45 GHz.

15. The diaper as claimed in claim 10, wherein the signal frequency of said micro antenna is 5.8 GHz.

16. The diaper as claimed in claim 2, wherein said signal transmitter is a micro speaker.

17. The diaper as claimed in claim 1, wherein said receiving module includes an alarm for giving a caution by whistling, lighting, or glittering to inform changing the diaper.

18. The diaper as claimed in claim 1, wherein said receiving module is a mobile device.

19. A diaper, comprising:
a body;
a sensing module disposed on said body for detecting humidity of said body and wirelessly transmitting an electrical signal converted from the humidity; and
a transmitting/receiving module for providing power to said sensing module coupled with said transmitting/receiving module to generate a induction current, and receiving an electric signal from said transmitting/receiving module to send a warning signal.

20. The diaper as claimed in claim 19, wherein said sensing module includes a humidity sensing element, a signal processor, and a sensor.

21. The diaper as claimed in claim 19, wherein said sensing module is disposed on a flexible circuit board comprising a polyimide film (PI).

22. The diaper as claimed in claim 19, wherein said sensing module is disposed on a flexible circuit board comprising a polyester film (PET).

23. The diaper as claimed in claim 19, wherein said sensing module is a disposable sensing module.

24. The diaper as claimed in claim 19, wherein said sensing module is a reusable sensing module.

25. The diaper as claimed in claim 20, wherein the material of said humidity sensing element is polymer material.

26. The diaper as claimed in claim 19, wherein said receiving module includes an alarm for giving a caution by whistling, lighting, or glittering to informing changing the diaper.

27. The diaper as claimed in claim 19, wherein said receiving module is a fixed device.
